(19) United States
(12) Patent Application Publication
(10) Pub. No.: US 2016/0080743 A1
(43) Pub. Date: Mar. 17, 2016

(54) SYSTEMS AND METHODS FOR SUBJECT-ORIENTED COMPRESSION

(71) Applicant: TMM, Inc., Wilmington, DE (US)

(72) Inventors: Vitus Lee, Vancouver (CA); David Kerr, Vancouver (CA); Oliver Zimmerman, Vancouver (CA)

(73) Assignee: TMM, Inc., Wilmington, DE (US)

(21) Appl. No.: 14/852,861

(22) Filed: Sep. 14, 2015

Related U.S. Application Data
(60) Provisional application No. 62/049,894, filed on Sep. 12, 2014.

(51) Int. Cl. H04N 19/134; G06F 3/0486; G06F 17/30; G06T 7/20; H04N 19/124; G06K 9/46

(52) U.S. Cl. CPC H04N 19/134; H04N 19/124; G06K 9/4671; G06F 17/3079; G06T 7/2033; G06F 3/0486

(57) ABSTRACT

Examples of the present disclosure relate to performing subject oriented compression. A content file, such as a video file, may be received. One or more subjects of interest may be identified in the content file. The identified subjects of interest may be associated with a quantization value that is less than a quantization value associated with the rest of the content. When the content is compressed/encoded, the subjects of interest are compressed/encoded using their associated quantization value while the rest of the content is compressed/encoded using a larger quantization value.

### PRIORITY

The present application claims priority to U.S. Provisional Patent Application No. 62/049,894, entitled “Systems and Methods for Subject-Oriented Compression,” filed on Sep. 12, 2014, which is hereby incorporated in reference in its entirety.

### BACKGROUND

Modern video compressors have functionality to perform adaptive quantization of individual blocks within a video frame. The adaptive quantization values are picked automatically and have been successful in reducing file sizes. However, the techniques for automatically picking adaptive quantization values do not result in optimal compression. For example, the automated techniques are not able to aggressively modify the quantization values because such automated techniques are unable to distinguish between foreground and background subjects in an image and/or video. It is with respect to this general environment that embodiments of the present disclosure have been contemplated.

### SUMMARY

Aspects disclosed herein incorporate feedback into a compression process to identify foreground and background subjects such that the different subjects may be treated separately during the compression process. This data identifying the different subjects may then be processed using a Subject-Oriented Compression (SOC) algorithm. The SOC algorithm may compress the foreground subject(s) using a very low quantization value, thereby preserving the visual quality of foreground subjects. Subjects that fall outside the foreground may be compressed using a high quantization value, thereby significantly decreasing the overall file size while still maintaining visual quality for subjects of interest.

This summary is provided to introduce a selection of concepts in a simplified form that are further described below in the Detailed Description, below. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 is an exemplary embodiment illustrating the identification of subjects of interest.

FIG. 2 is an exemplary embodiment of a method of subject-oriented compression.

FIG. 3 is an exemplary method for performing subject tacking using an editor

FIG. 4 provides an example of a metadata file that comprises information about one or more subjects of interest.

FIG. 5 provides yet another example of a metadata file that may be employed with the examples disclosed herein.

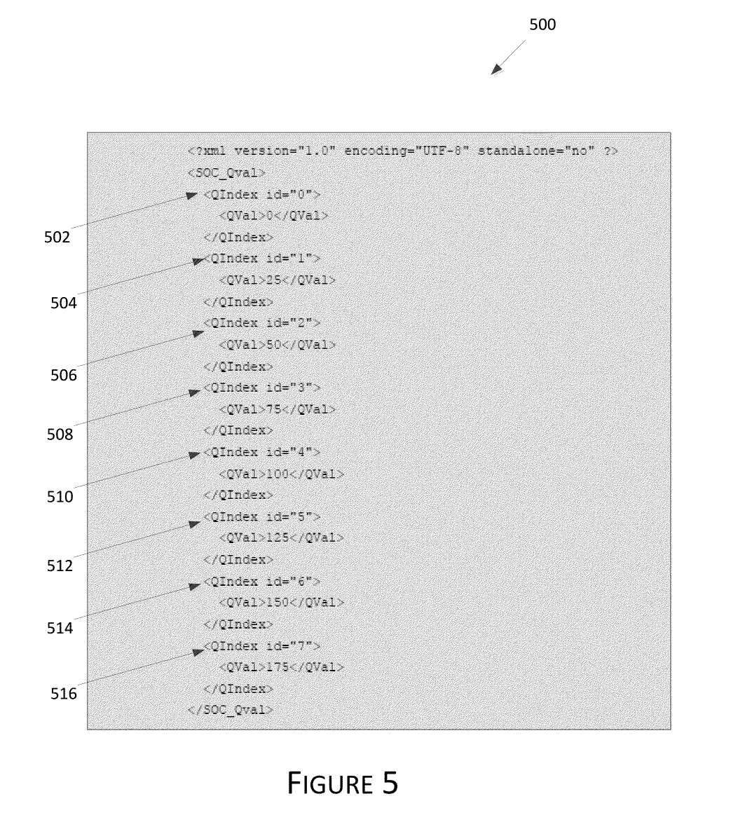

FIG. 6 illustrates an exemplary GUI that may be employed with the aspects disclosed herein

FIG. 7 illustrates one example of a suitable operating environment in which one or more of the present embodiments may be implemented.

FIG. 8 is an embodiment of an exemplary network in which the various systems and methods disclosed herein may operate.

### DETAILED DESCRIPTION

Modern video compressors have functionality to perform adaptive quantization of individual blocks within a video frame. The adaptive quantization values are picked automatically and have been successful in reducing file sizes. However, the techniques for automatically picking adaptive quantization values do not result in optimal compression. For example, the automated techniques are not able to aggressively modify the quantization values because such automated techniques are unable to distinguish between foreground and background subjects in an image and/or video. Embodiments disclosed herein incorporate user feedback into a compression process to identify foreground and background subjects such that the different subjects may be treated separately during the compression process. This data identifying the different subjects may then be processed using a Subject-Oriented Compression (SOC) algorithm. The SOC algorithm may compress the foreground subject(s) using a very low quantization value, thereby preserving the visual quality of foreground subjects. Subjects that fall outside the foreground may be compressed using a high quantization value, thereby significantly decreasing the overall file size while still maintaining visual quality for subjects of interest.

The SOC embodiments disclosed herein provide a simple yet effective mechanism to reduce the size of multimedia files (e.g., video files, image files, etc.). For ease of explanation, the embodiments described herein focus on performing Subject-Oriented Compression on a video or image file. However, one of skill in the art will appreciate that the embodiments disclosed herein may be practiced with other types of media. In such embodiments, identification of the subject of interest may differ. For example, in an audio file, a conversation may be identified as a subject of interest and be compressed using a lower quantization value than the quantization valued used to compress background noise. Accordingly, one of skill in the art will appreciate that the embodiments disclosed herein can be employed with many different types of files.

A related topic is Adaptive Quantization (AQ) which manipulates the differences between quantization values to achieve a rule-based quantization. AQ uses different algorithms to automatically improve the quality of images in different areas. AQ often uses rules based on some form of psyco-physics approach to human perception to attain generally acceptable results. The embodiments disclosed herein provide the ability to identify the foreground (e.g., subject(s) of interest) and maintain high visual quality for the identified subject(s) of interest. The background then may be aggressively compressed to a tolerable level, thereby reducing the size of the video, which allows the file to be more easily transmitted in lower bandwidth situations and also provides savings in the amount of storage required to save the video file.

In order to save file size and to increase compression ratio, the embodiments disclosed herein provide for selecting subjects that may be compressed less than the other subjects in a file. A subject may be a portion of a file that is less than the whole file. For example, a subject may be an object, a region, a grouping of pixels, etc. If the file is an image or video file, the selected subject may be visually more important to the viewer than others subjects in the image or video. In such embodiments, depending on the difference of compression, the perceived visual difference between the subject(s) of interest and the background should be negligible and acceptable—even though the file size as a whole is reduced due to the application of more aggressive compression to other subjects that are not of interest. If the file is a video file, a subject may be a range of frequencies, background noise, etc. In other types of multimedia files, a subject may be identified by the type of content, e.g., an embedded image in a document. One of skill in the art will appreciate that a subject may identify different subject matter of interest depending on the type of file being compressed using the SOC embodiments disclosed herein.

In embodiments in which an image or video is being compressed, in order to modify the quantization values used for compression, a reliable segmentation map may be created for each image. The following are exemplary modes for creating a reliable segmentation map. In one example, manual, user-driven, approach may be employed whereby subjects may be selected by a user via a graphical user interface (GUI). Alternatively, an automatic approach may be employed whereby subjects may be automatically selected based on, for example, movement, size, location, psycho-physics, etc.

In the past, automatic algorithms have proven to be unreliable, especially in situation where intended subject(s) (e.g., a subject of interest to a viewer) are obscured or occluded by other objects. To alleviate such problems, the embodiments disclosed herein may incorporate some form of user assistance. A GUI may be provided that allows a user to change and/or switch automatically-selected subjects.

In embodiments, a subject selection method may differ depending on the content, e.g. the type of images/videos being compressed. In the case of surveillance videos, for example, the scene changes may be smooth in comparison to other types of content, such as a movie, which may have more evident scene changes. For example, in a surveillance video, the background of the video footage is often stationary or limited to a single area. On the other hand, movies often have multiple scene changes in which the entire background of the video may be different. As such, in surveillance type videos, selected subjects may not abruptly change shape/orientation/size in between scenes. However, this is not the case with movie content. In the latter case, user intervention may be provided to aid in the identification of a subject of interest.

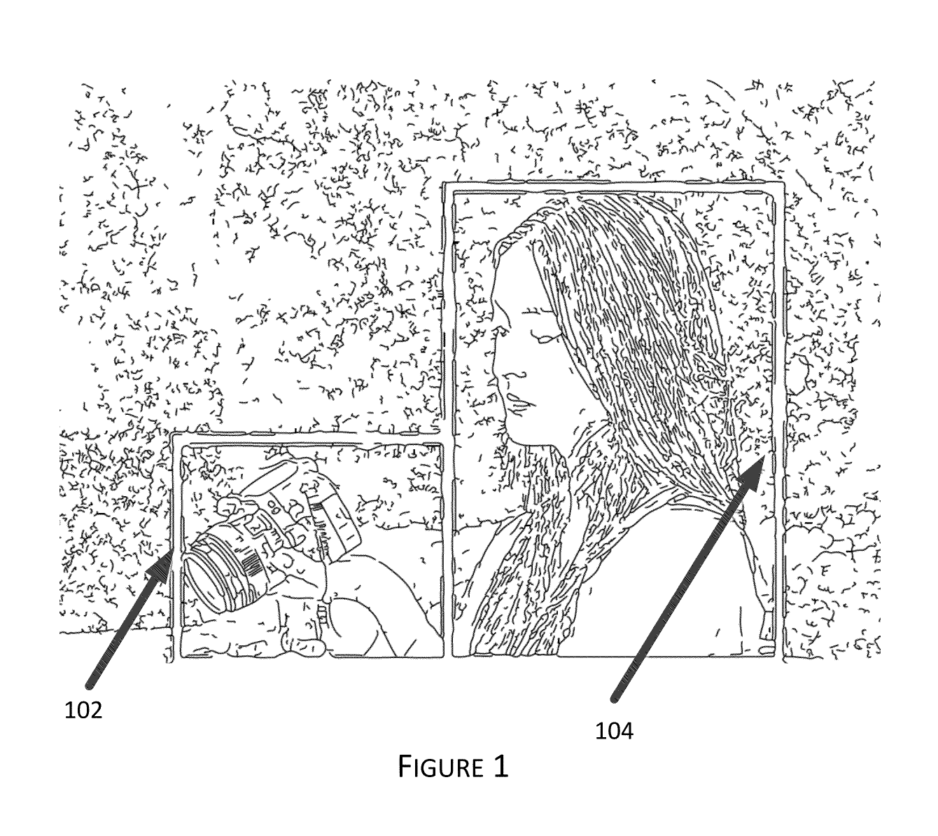

In examples, manual subject selection may be performed using a GUI that receives input that marks or otherwise identifies a subject or subjects of interest in an image or in frame of a video scene. FIG. 1 is an exemplary GUI 100 that may be employed with the aspects disclosed herein. As discussed above, the GUI 100 may be capable of receiving input that identifies a subject of interest. For example, indicators 102 and 104 displayed in FIG. 1 may result from the GUI 100 receiving input that identifies two different subjects of interest, e.g., the camera highlighted by indicator 102 and the woman highlighted by indicator 104. In the depicted example, indicators 102 and 104 are illustrated as rectangular boundaries surrounding the subjects of interest. However, one of skill in the art will appreciate that other types of graphical indicators may be employed without departing from the scope of this disclosure. In still further examples, a subject of interest may be indicated using coordinates or other location defining information. Upon initial identification, the one or more identified subjects may be tracked, for example, by employing a hierarchy of tracking algorithms to track the one or more identified subjects in subsequent frames of the same scene. In examples, a GUI may be operable to receive input that corrects a subject that may not have been accurately tracked and/or receive indications of new subjects to track which may have entered the scene. In examples, such a process may be repeated for each scene in the video and the data may be stored for the compression process.

In aspects, the identified subject(s) may be stored in a segmentation map (e.g., as metadata) in a file. For example, the segmentation may be an XML file that contains XML information for one or more selected subjects. In examples, the segmentation map on may identify the subject(s) using coordinates, pixel location, regions or section, etc. The segmentation map may be used by a compressor/encoder during quantization of the image. In examples, the segmentation map may specify an intended quantization value for the identified subject(s) and an intended quantization value for the rest of the image. In other embodiments, the quantization values for the identified subject(s) and the rest of the image may be automatically determined, for example, based on the type of content being compressed, a device type, an application, etc. The difference between the two quantization values may create a quantization difference. Depending on the quantization difference, the resulting image (e.g., compressed and/or encoded image) may have visually-perceivable differences between the identified subject(s) and the rest of the image. In embodiments, a visual tolerance level may be defined by input received from a user, an application, a device, etc. Quantization values may be selected based upon a visual tolerance level. However, in examples, improvement in the overall compression ratio may depend on the quantization difference, the number of selected subjects, and/or the sizes of the selected subjects.

In examples, a region may be defined around subject of interest. The region bounding may be rectangular-based, contour-based, circular-based, etc. In embodiments, the bounding method may affect the amount of metadata required to describe the selected subjects and/or encoding speed. As such, a method such as the contour-based method may be preferable in some scenarios.

In certain aspects, the segmentation map may be used during compression. The decoding process does not need and should not depend on this segmentation map. In examples, the SOC systems and methods disclosed herein may utilize a codec capable of supporting multiple image segments within an image, such as, for example X.264 and VP9. However, the SOC embodiments disclosed herein may be employed with any compression methods. Table 1 below shows the differences between the quantization values used between a subject and the rest of the video as well the gain in overall compression ratios obtained by employing the aspects disclosed herein.

TABLE 1
File Size Comparison at Different Quality Settings

| | | | Percent Gain |
|---|---|---|---|
| Quality | Quantization Difference | File Size (KB) | (%) |
| High | 0 | 1110 | 0 |
| High | 50 | 870 | 21.62 |
| High | 100 | 809 | 27.12 |
| High | 150 | 786 | 29.19 |
| Medium | 0 | 326 | 0 |
| Medium | 50 | 299 | 8.28 |
| Medium | 100 | 285 | 12.58 |
| Medium | 150 | 283 | 13.19 |
| Low | 0 | 148 | 0 |
| Low | 50 | 135 | 8.78 |
| Low | 100 | 134 | 9.46 |
| Low | 150 | 132 | 10.81 |

By reducing the image quality of the background, for example, by using a higher quantization value, the file size of the entire image can be reduced. The effects of the reduction are greater for higher quality video and/or images. For examples, as shown in Table 1, the SOC examples disclosed herein provide for a significant decrease in file size at high quality settings. Furthermore, there is little difference in the perceived visual quality between 0 and 50 quantization differences. AS the quantization differences increase, the decrease in visual quality becomes more perceptible. Further, testing has shown that the boundary between the selected subject of interest and the rest of the image is not visually distinguishable. That is because, in examples, block segmentation mapping may be employed to automatically adjust quality levels on boundaries to blend boundary with the rest of the image.

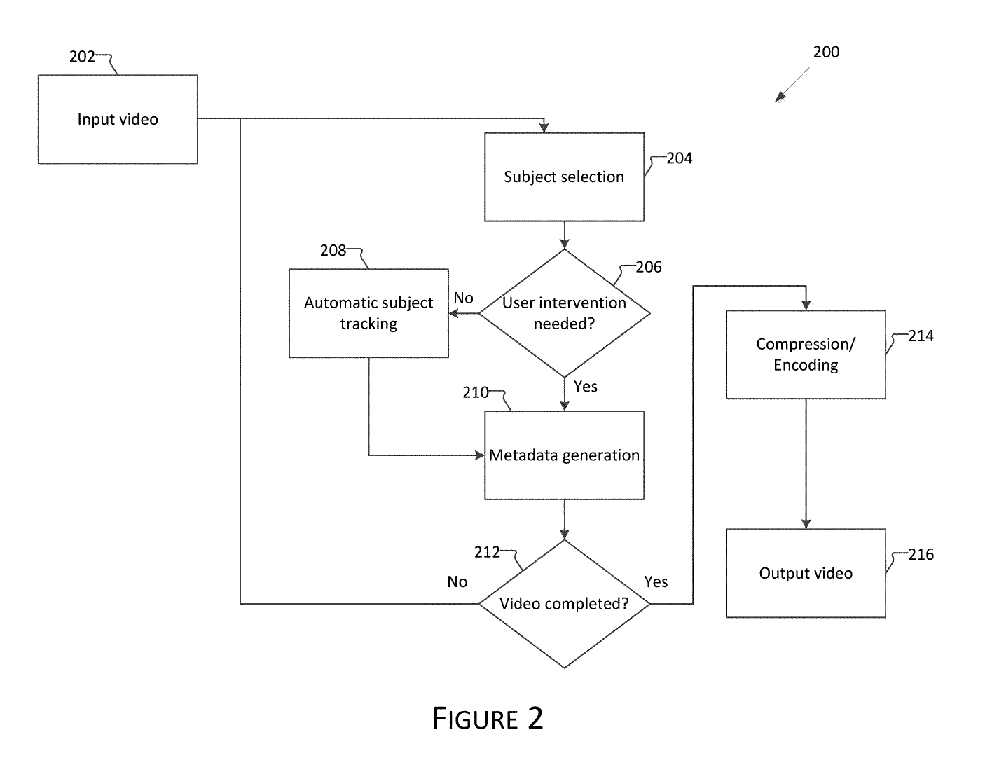

FIG. 2 is an exemplary method 200 for performing subject-oriented compression. The method 200 may be implemented in software, hardware, or a combination of software and hardware. The method 200 may be performed by a device such as, for example, a mobile device or a television. In embodiments, the method 200 may be performed by one or more general computing devices. In one example, the method 200 may be performed by a video encoder. In alternate examples, the method 200 may be performed by an application or module that is separate from a video encoder. While the method 200 is described as operating on video content, one of skill in the art will appreciate that the process described with respect to the method 200 may operate on other content types as well.

Flow begins at operation 202 where video input may be received. The video input may be streamed video data or a video file. In examples, the video input may be raw data streamed from a camera. Flow continues to operation 204 where one or more subjects of interest are identified. In one example, the one or more subject may be identified automatically. For example, the subjects may be automatically identified based on, movement, size, location, psycho-physics, etc. In alternate examples, the one or more subjects may be identified by user input received via an interface. In such embodiments, a graphical user interface (“GUI”) may display an image. In response to displaying the image, the GUI may be operable to receive user input identifying one or more subjects of interest. In embodiments, the GUI may provide means to select subjects of interest. The GUI may skip ahead through a video examining of every frame. When a tracking of a subject of interest is lost, the GUI may stop skipping ahead through the frames and alert the user to intervene and identify the subject of interest. In examples, an automatic tracking mode may perform various tracking algorithms, such as subject movement prediction based on optical flow or other tracking methods may be employed by the to track a subject of interest. In embodiments, the GUI may provide the option for user intervention with automatic tracking or to the option to let the automatic tracking process continue unaided. The automatic tracking may be set at the beginning of a session for identifying subjects of interest. In further examples, default settings the automatic tracking may be applied. The setting for the automatic tracking may be applied for the entire video or for a group of pictures (GOP). The determination of whether to apply the settings to the entire video or just a GOP may be based received user input. In further aspects, the GUI may provide a frame selection method which allows for the navigation to specific frames. Such functionality provides the ability to re-select a previously selected subject of interest, select new subjects of interest, and/or deselect or remove a previously selected subject of interest. While specific example of identifying a subject have been described with respect to operation 204, one of skill in the art will appreciate that other mode may be employed to identify a subject of interest at operation 204.

Flow continues to decision operation 206 where a determination may be made as to whether or not additional input is required to identify the subject of interest. For example, additional user input may be required if the subject moves behind another object, if there is a scene change, if the subject is a morphable subject, e.g., a subject that changes shape such as a flame, etc. If additional input is not needed, flow branches No to operation 208 where automatic subject tracking may be performed to identify the subject of interest as it moves (e.g., identifying the subject of interest across different frames). In aspects, a hierarchy of tracking algorithms may be employed at operation 208. Upon completion of the automatic subject tracking, flow continues to operation 210. Returning to decision operation 206, if additional input is required, a GUI may be capable of receiving additional input that identifies the subject of interest as it moves (e.g., identifying the subject of interest on different frames). After receiving additional input flow branches Yes to operation 210.

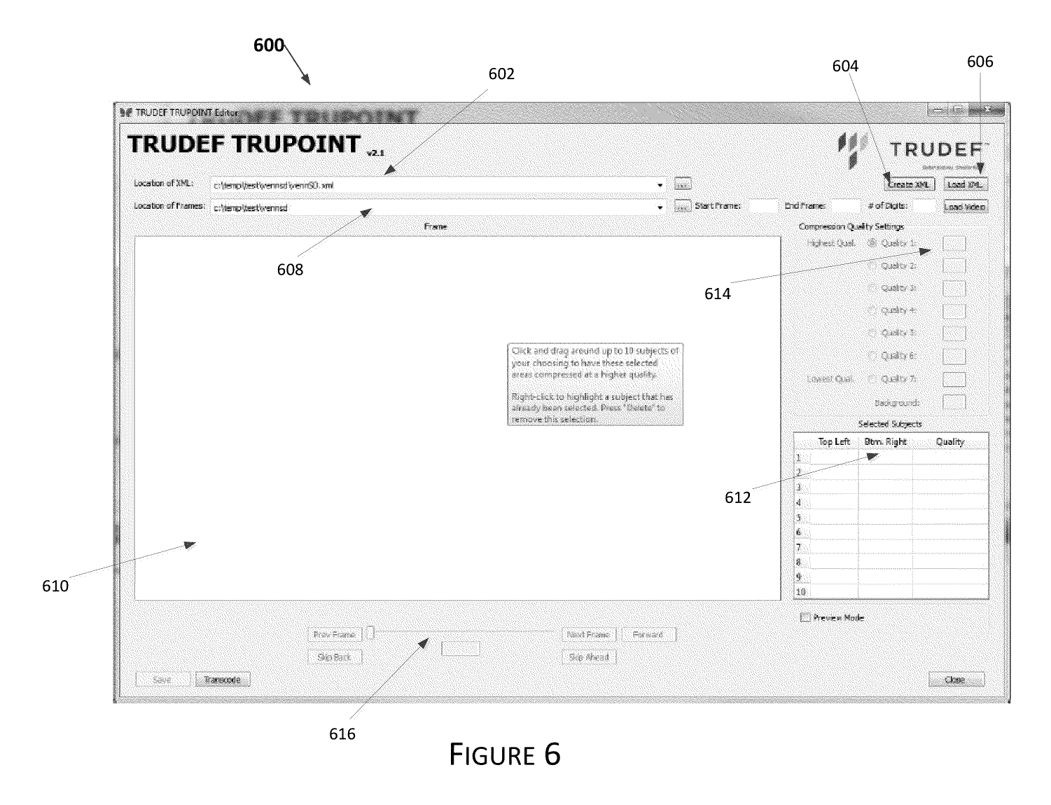

At operation 210, metadata may be generated that identifies the subject as it moves across frames. The metadata may identify a position or coordinate on a screen, a region, a group of pixels, etc. In one embodiment, the metadata may be stored in an XML file. However, one of skill in the art will appreciate that the metadata may be stored in other forms or file types. In alternate examples, the metadata may not be stored at all. Rather, the metadata may be directly provided or streamed to a compression and/or encoding module or component. Flow continues to decision operation 212 where a determination is made as to whether or not the video is completed. If the video is not completed, flow branches No and returns to operation 204. However, if the video is completed, flow branches Yes to operation 214. At operation 214, the video data may be compressed and/or encoded. In embodiments, the compression and/or encoding performed may apply different quantization values to different portions of the image. In embodiments, the subjects of interest may be compressed using a very low quantization value, thereby preserving the visual quality of subjects of interest. All other portions of the image may be compressed using a high quantization value, thereby significantly decreasing the overall file size while still maintaining visual quality for subjects of interest. In examples, the determination of what portions to compress using a lower quantization may be indicated by the metadata generated at operation 210. Upon completion of the compression and/or encoding, flow continues to operation 216 where a video generated using SOC is output. The video may be output as a file or a stream data. Additional aspects of the disclosure provide for a “preview” mode that may be accessed using the GUI. The preview mode is operable to receive input that transitions between groups of frames (e.g., via a slide bar such as slide bar 616 in FIG. 6) without affecting existing metadata.

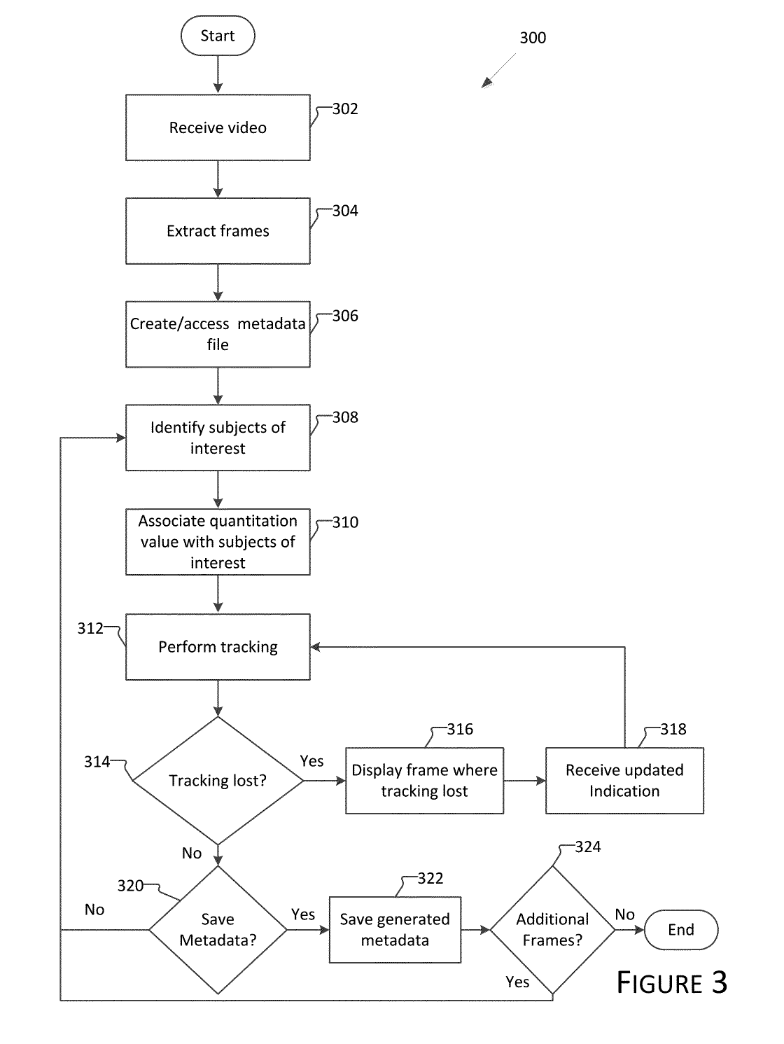

FIG. 3 is an exemplary method for performing subject tacking using an editor. The method 300 may be implemented in software, hardware, or a combination of software and hardware. The method 300 may be performed by a device such as, for example, a mobile device or a television. In embodiments, the method 300 may be performed by one or more general computing devices. Flow begins at operation 302 where a video is received by the editor. In one example, the device performing the method may receive input indicating the pathname and the location of the video. For example, FIG. 6 illustrates an exemplary GUI 600 that may be employed with the aspects disclosed herein. As illustrated in the exemplary GUI, a user interface element 602 may be provided that allows the user to specify the location of the video file. In the illustrated example, user interface element 602 is a text box operable to receive a path and file name for a video file. In alternate examples, user interface element 602 may be a drop down menu that allows the selection of a specific video file, may be a file browser that provides for the selection of the video file, or may be any other type of user interface element operable to receive input indicating the location of a video file. The received input may be used to retrieve the video from storage. In other examples, the video may be provided to the editor via another application or may be streamed over a network connection. Flow continues to operation 304, where one or more individual frames are extracted from the video. In one example, the one or more individual frames may be parsed upon receiving the video retrieved at operation 302. In other examples, the individual frames may be parsed prior to receiving the video at operation 302. As such, operation 302 may comprise retrieving the individual frames of the video.

Flow continues to operation 306 where one or more metadata files are created. In examples, the one or more metadata files may include information used to identify subjects of interest within the video and/or individual frames (e.g., a metadata description of one or more subjects of interest). In further examples, the one or more metadata files may store different quantization values used for the video and/or individual frames (e.g., metadata describing global quantization values for a video or image). In one aspect, one or more new metadata files may be created at operation 306. In other examples, if there are preexisting metadata files, for example, upon resumption of processing of the content, the one or more preexisting metadata files may be retrieved and/or loaded at operation 306. Referring again to exemplary GUI 600, a user interface control may be provided that allows for the creation of a new metadata file, such as control 604. Alternatively or additionally, a user interface control may be provided that allows for the selection and loading existing metadata files, such as control 606. Furthermore, a user interface component may be provided that allows for the selection of an existing metadata file, such as user interface component 608. In examples, user interface component 608 may operate similar to user interface component 602.

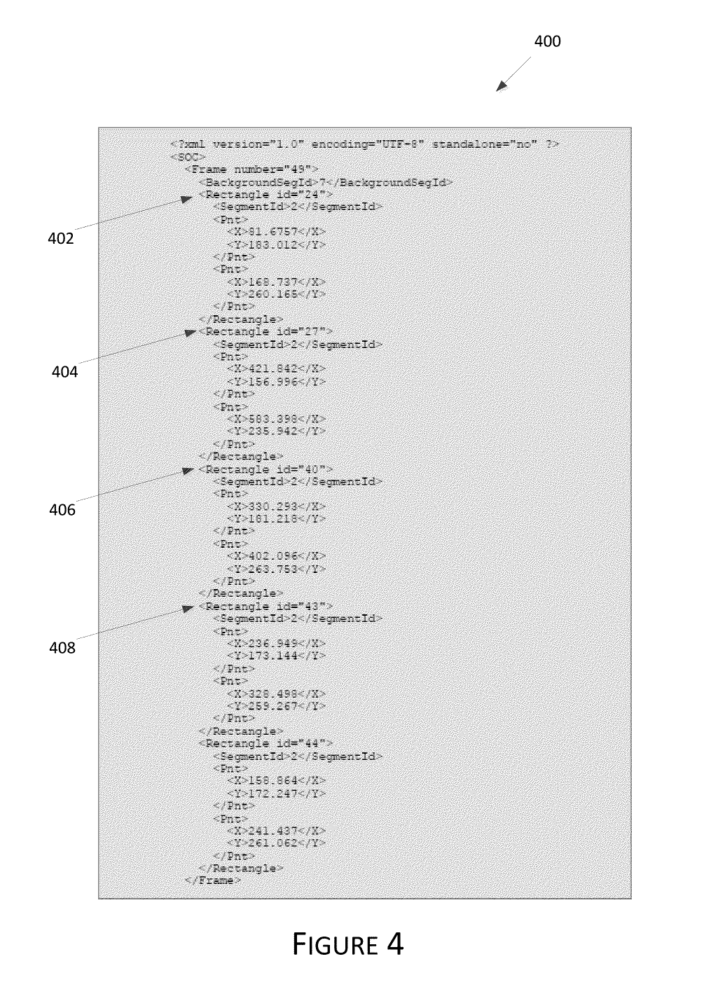

FIG. 4 provides an example of a metadata file 400 that comprises information about one or more subjects of interest. The depicted examples provides information about an individual frame, frame 49 denoted by the <Frame number=“49”> tag. The metadata file 400 may store information one or more subject of interests, the location and size of the bounding boxes associated with each subject of interest, and a quantization value associated with each subject of interest. In the depicted example, four subjects of interest 402, 404, 406, and 408 denoted by the <Rectangle Id> tag. The identifier for each subject of interest may be a unique identifier. In examples, each subject of interest may also be associated with a segment identifier that corresponds to a quantization value. The associated quantization value may be stored in a separate metadata file. The segment identifier may be used to map the quantization value from one metadata file to a subject of interest in a second metadata file. In further examples, the location of the boundary box may be identified by the <pnt> tag. In the depicted embodiment, each subject identifier includes two different coordinates identified by the <pnt> tag which correspond to a top left corner and a bottom right corner of a bounding box. While the metadata file 400 is depicted as including rectangular bounds for each subject of interest, one of skill in the art will appreciate that other types of information may be included in the metadata file to identify a subject of interest.

FIG. 500 provides yet another example of a metadata file 500 that may be employed with the examples disclosed herein. Metadata file 500 may store different quantization values 502-516. In examples, each quantization value may be associated with unique identifier denoted by the <Qindex> tag. In examples, the unique identifier may correspond to a segment identifier, such as the segment identifier depicted in metadata file 400 of FIG. 4. The actual quantization value may be denoted by the <QVa1> tags.

Returning to FIG. 3, flow continues from operation 306 to operation 308 where one or more subjects of interest are identified. In one example, the one or more subjects of interest may be identified automatically. For example, the one or more subjects of interest may be identified by analyzing the video (or frame) for subjects indicated by movement, size, location, psycho-physics, etc. In another example, the device performing the method 300 may provide a GUI capable of receiving input that identifies the one or more subjects of interest. The GUI may display a frame or a series of frames. In one example, the GUI may be operable to receive input indicating a bounding box around a subject of interest for a particular frame. For example, a bounding box may be drawn by receiving a click-and-drag input at the GUI. In examples, multiple bounding boxes may overlap. In other examples, a bounding box may go out of bounds (e.g., outside of the frame). For example, referring to FIG. 6, GUI 600 may include display 610 which is operable to display a current frame. Although not shown, the display 610 may also be operable to receive input that identifies one or more subjects of interests in the currently displayed frame. Alternatively, the GUI may be operable to receive coordinates indicating the location of a subject of interest. For example, referring to GUI 600, a table of coordinates 612 may be provided that is operable to receive the coordinates of the one or more subjects of interest. In examples, the coordinates for the top left and bottom right of a bounding box around the subject of interest may be received by table 612. In further examples, a quantization value, or quality value, may be associated with each subject of interest, as displayed in the exemplary table 612. In addition to receiving input identifying subjects of interest, input may also be received to remove subjects of interest at operation 308. For example, a bounding box may be deleted.

Upon identifying the one or more subjects of interest, flow continues to operation 310 where a quantization value is associated with a subject of interest. In one example, the quantization value associated with a subject of interest may be automatically determined. For example, the quantization values may be determined based upon a characteristic of the subject of interest (e.g., hue, size, color, etc.). Alternatively, the quantization value for a specific subject of interest may be determined based upon received input from a user or another application. For example, a GUI may be operable to provide for the selection of a specific subject of interest and a corresponding quantization value may be received for the specific subject of interest. When multiple subjects of interest have been identified, the same or different quantization values may be used for each subject of interest. Additionally, the GUI may also be operable to receive a quantization value for the background (e.g., areas not identified as a subject of interest). For example, referring again to FIG. 6, GUI 600 may include a quality settings area that is operable to receive different quantization values that can be assigned to the different subjects of interest and/or to the background. In examples, the quality settings area may contain a number of controls, such as control 614, operable to receive input defining a quantization value and to display the different quantization levels.

After having identified the one or more subjects of interest, flow continues to operation 312 where feature tracking is performed for the one or more subjects of interest. A number of different techniques of tracking objects through a scene are known to the art, any of which may be employed with the embodiments described herein. A hierarchy of tracking algorithms may be implemented to ensure the best possible matches in each frame. Feature Tracking has proven to be successful at tracking rigid objects that do not have repeated textures. Feature tracking works exceptionally well when tracking regions. Feature Tracking is be moderately successful when tracking the woman in the sequence depicted in FIG. 1, but a color or face based tracker will have a higher probability of success. Tracking subjects may be difficult. Tracking depends on whether the subjects to be tracked are rigid objects, morph-able objects, etc. Tracking may also depends on whether the subject will be obscured or is rotating. As such, various tracking methods may be employed to account for the different scenarios. These methods may include tracked-by-color, tracked-by-template-matching, feature tracking, optical flow, etc. In examples, tracking of the subject of interest may result in a GUI being updated to identify the location of the subject of interest in a specific frame. For example, table 602 of the GUI 600 may be updated with new coordinates for each subject of interest as the subjects of interest change locations across the different frames.

In examples, tracking of the one or more subject may be performed for the duration of the video or group of pictures. However, there are a number of situations where tracking can be lost. Such situations include the tracked subject of interest moving out of the scene, the subject of interest is occluded by something in the scene, and/or if algorithm loses tracking due to changes in subject of interest's appearance. As such, flow continues to decision operation 314 where a determination is made as to whether tracking for a subject of interest is lost. If it is determined that the tracking is lost, flow branches Yes to operation 316. At operation 316, a notification may be generated that tracking of the subject of interest is not available in the specific frame. As such, in examples, the frame where the tracking was lost may be displayed along with a prompt asking a user and asked to confirm whether the subject of interest should still be tracked. If the subject is no longer in the frame, input may be received indicating that the subject of interest should no longer be tracked. However, if the subject is in the frame and tracking was lost due to changes in the subject or some other tracking failure, flow continues to operation 318 where input may be received that reselects or otherwise identifies the subject of interest for continued tracking Flow then returns to operation 312 where tracking is continued until the subject of interest is again lost or the video or group of pictures completes.

Returning to decision operation 314, if tracking is not lost, flow branches No to decision operation 320. At decision operation 320, a determination may be made as to whether or not the metadata should be saved. In one example, the metadata should be saved if tracking of the subject of interest has completed. In other examples, the metadata may be saved periodically. In still further examples, the decision as to whether or not to save the metadata may be based upon receiving input that indicates that the data should be saved. If it is determined that the metadata should not be saved, flow branches No and returns to operation 308. In examples, tracking of the subject of interest may continue until the video completes. Additionally, new subjects of interests may be introduced in later frames. Thus, in examples, flow returns to operation 308 to identify potential new subjects of interest (or identify a lost subject of interest) and the method 300 continues. Returning to decision operation 320, if it is determined that the metadata should be saved, flow branches Yes to operation 322 and the metadata generated during the tracking may be saved to the metadata files created, or opened, at operation 306. After saving the metadata, flow continues to decision operation 324 where a determination is made as to whether additional frames exist. In examples, the identification and tracking of subjects of interest continue until the entire video has completed. Thus, if additional frames exist, flow branches Yes and returns to operation 308 where the method 300 continues until the entire video has been processed. If there are no additional frames, flow branches No and the method 300 completes.

As previously discussed the metadata files may then be used by a compressor and/or encoder to perform subject oriented compression on the videos. For example, the one or more metadata files may be loaded by a compressor/encoder. The compressor/encoder may then sets the subject oriented compression information in the segmentation map along with the quantization values based off of the metadata files. This data may then be used during quantization and the resulting file will be significantly reduced in size when compared to files not using the subject oriented compression data. The one or more metadata files are no longer needed once compression/encoding completes. The one or more metadata files may be saved if the compression/encoding is to be repeated. Alternatively, the one or more metadata files may also be placed into the original video file.

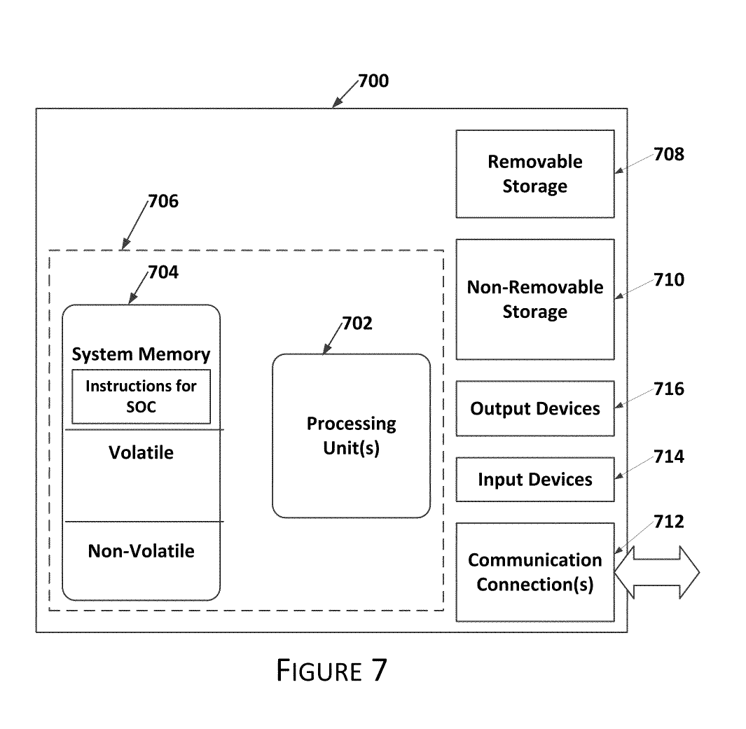

Having described various embodiments of systems and methods that may be employed to subject-oriented compression, this disclosure will now describe an exemplary operating environment that may be used to perform the systems and methods disclosed herein. FIG. 7 illustrates one example of a suitable operating environment 700 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 700 typically includes at least one processing unit 702 and memory 704. Depending on the exact configuration and type of computing device, memory 704 (storing, instructions to perform the subject-oriented compression embodiments disclosed herein) may be volatile (such as RAM), non-volatile (such as ROM, flash memory, etc.), or some combination of the two. This most basic configuration is illustrated in FIG. 7 by dashed line 706. Further, environment 700 may also include storage devices (removable, 708, and/or non-removable, 710) including, but not limited to, magnetic or optical disks or tape. Similarly, environment 700 may also have input device(s) 714 such as keyboard, mouse, pen, voice input, etc. and/or output device(s) 716 such as a display, speakers, printer, etc. Also included in the environment may be one or more communication connections, 712, such as LAN, WAN, point to point, etc. In embodiments, the connections may be operable to facility point-to-point communications, connection-oriented communications, connectionless communications, etc.

Operating environment 700 typically includes at least some form of computer readable media. Computer readable media can be any available media that can be accessed by processing unit 702 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, microwave, and other wireless media. Combinations of the any of the above should also be included within the scope of computer readable media.

The operating environment 700 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

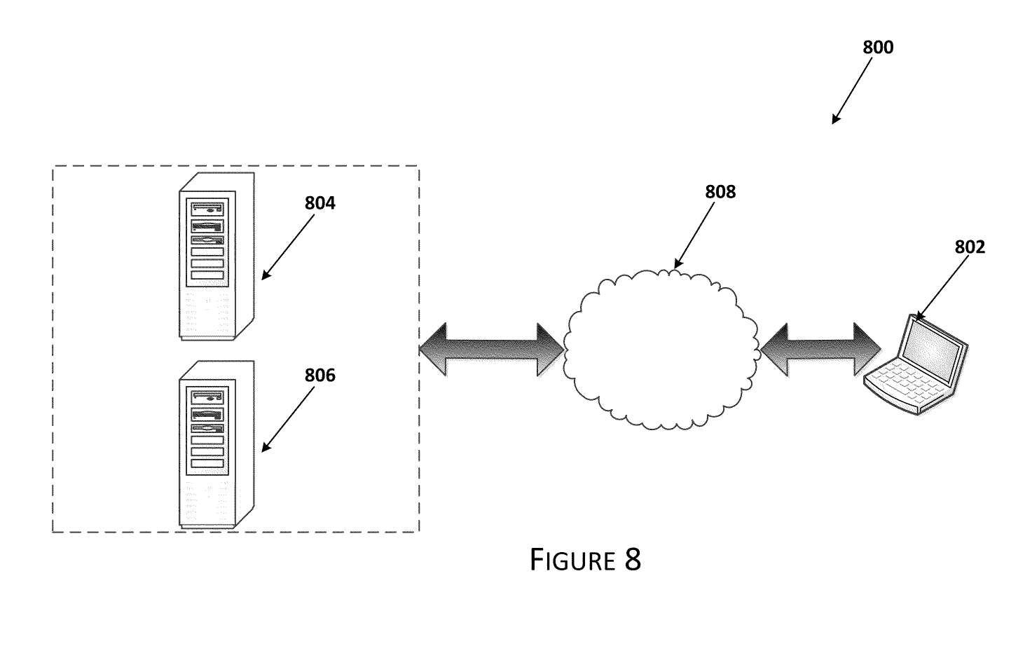

FIG. 8 is an embodiment of a system 800 in which the various systems and methods disclosed herein may operate. In embodiments, a client device, such as client device 802, may communicate with one or more servers, such as servers 804 and 806, via a network 808. In embodiments, a client device may be a laptop, a personal computer, a smart phone, a PDA, a netbook, a netbook, a tablet, a phablet, a convertible laptop, a television, or any other type of computing device, such as the computing device in FIG. 3. In embodiments, servers 804 and 806 may be any type of computing device, such as the computing device illustrated in FIG. 3. Network 808 may be any type of network capable of facilitating communications between the client device and one or more servers 804 and 806. Examples of such networks include, but are not limited to, LANs, WANs, cellular networks, a WiFi network, and/or the Internet.

In embodiments, the various systems and methods disclosed herein may be performed by one or more server devices. For example, in one embodiment, a single server, such as server 804 may be employed to perform the systems and methods disclosed herein. Client device 802 may interact with server 804 via network 808 in order to access data or information such as, for example, a video data for subject-oriented compression. In further embodiments, the client device 806 may also perform functionality disclosed herein.

In alternate embodiments, the methods and systems disclosed herein may be performed using a distributed computing network, or a cloud network. In such embodiments, the methods and systems disclosed herein may be performed by two or more servers, such as servers 804 and 806. In such embodiments, the two or more servers may each perform one or more of the operations described herein. Although a particular network configuration is disclosed herein, one of skill in the art will appreciate that the systems and methods disclosed herein may be performed using other types of networks and/or network configurations.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

This disclosure describes some embodiments of the present technology with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments are described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A method of performing subject-oriented compression, the method comprising:
identifying a subject of interest in an image;
compressing the subject of interest using a first quantization value; and
compressing the remainder of the image using a second quantization value, wherein the second quantization value is greater than the first quantization value.

2. The method of claim 1, wherein identifying the subject of interest comprises automatically identifying the subject of interest based on at least one characteristic of the subject of interest.

3. The method of claim 1, wherein identifying the subject of interest further comprises:
displaying a frame in a graphical user interface (GUI); and
receiving an indication of the subject of interest via the GUI.

4. The method of claim 3, wherein receiving the indication of the subject of interest comprises receiving a click-and-drag input.

5. The method of claim 1, wherein the subject of interest is identified by a bounding box.

6. The method of claim 1, further comprising:
identifying a second subject of interest; and
compressing the second subject of interest using the first quantization value.

7. The method of claim 6, wherein the first subject of interest and the second subject of interest overlap.

8. The method of claim 6, further comprising:
identifying a third subject of interest; and
compressing the third subject of interest using a third quantization value, wherein the third quantization value is different from the first quantization value and the second quantization value.

9. A system comprising:
at least one processor; and
memory encoding computer executable instructions that, when executed by the at least one processor, perform a method comprising:
receiving a video;
creating at least one metadata file;
identifying at least one subject of interest;
associating a quantization value with the at least one subject of interest;
tracking the at least one subject of interest; and
saving metadata generated during tracking to the at least one metadata file.

10. The system of claim 9, wherein creating at least one metadata file comprises:
creating a first metadata file, wherein the first metadata file comprises data about the at least one subject of interest; and
creating a second metadata file, wherein the second metadata file comprises data about at least one quantization value;

11. The system of claim 10, wherein saving metadata generated during the tracking comprises saving metadata about the at least one subject of interest to the first metadata file.

12. The system of claim 11, wherein the metadata comprises saved to the first metadata file comprises:
data identifying a frame;
data identifying a location for the at least one subject of interest; and
a segment identifier.

13. The system of claim 9, wherein tracking the at least one subject of interest comprises performing feature tracking.

14. The system of claim 13, wherein the method further comprises:
determining whether the at least one subject of interest is lost; and
generating a notification that the at least one subject of interest is not available for a specific frame.

15. The system of claim 14, wherein the method further comprises receiving input identifying the at least one subject of interest in the specific frame.

16. The system of claim 9, wherein the method further comprises associating at least one quantization value with the at least one subject of interest, wherein the at least one quantization value is less than a background quantization value.

17. The system of claim 16, wherein the method further comprises compressing the video, wherein the at least one subject of interest is compressed using the at least one quantization value and the rest of the video is compressed using the background quantization value.

18. A computer storage medium encoding computer executable instructions that, when executed by at least one processor, perform a method comprising:
receiving a video;
creating at least one metadata file;
identifying at least one subject of interest;
associating a quantization value with the at least one subject of interest;
tracking the at least one subject of interest;
saving metadata generated during tracking to the at least one metadata file; and
performing subject oriented compression on the video using the at least one metadata file.

19. The computer storage medium of claim 18, wherein the method further comprises associating at least one quantization value with the at least one subject of interest, wherein the at least one quantization value is less than a background quantization value.

20. The computer storage medium of claim 19, wherein performing subject oriented compression further comprises compressing the at least one subject of interest using the at least one quantization value.
